(19) United States
(12) Patent Application Publication
(10) Pub. No.: US 2024/0424600 A1
(43) Pub. Date: Dec. 26, 2024

(54) OPTICAL COHERENCE TOMOGRAPHY DEVICE FOR A LASER MACHINING SYSTEM AND LASER MACHINING SYSTEM THEREWITH

(71) Applicant: Precitec GmbH & Co. KG, Gaggenau (DE)

(72) Inventors: Igor Shkarban, Rheinstetten (DE); Rüdiger Moser, Malsch (DE); Li Wen Chang, Rastatt (DE)

(21) Appl. No.: 18/749,864

(22) Filed: Jun. 21, 2024

(30) Foreign Application Priority Data
Jun. 22, 2023 (DE) 10 2023 116 430.9

(51) Int. Cl. B23K 26/03; B23K 26/38

(52) U.S. Cl. CPC B23K 26/032; B23K 26/38

(57) ABSTRACT

An optical coherence tomography device for a laser machining system for measuring distance to an object in a predetermined distance range comprises: a measuring arm for directing a measuring light beam at the object; a reference arm for guiding a reference beam with a plurality of reference sections having different measuring ranges; and a controllable switching element for switching between the reference sections of the reference arm. The measuring range of each reference section comprises a negative active measuring range and a positive active measuring range, between which a dead zone is located. The dead zone of one of the reference sections is overlapped by a positive or negative active measuring range of at least one other reference section. The positive and negative active measuring ranges of the reference sections together cover the predetermined distance range.

### CROSS-REFERENCE TO RELATED APPLICATIONS

This application claims priority to German Patent Application No. 10 2023 116 430.9, filed on Jun. 22, 2023, which is hereby incorporated by reference in its entirety.

### FIELD OF THE INVENTION

The present disclosure relates to an optical coherence tomography device for a laser machining system for measuring the distance to an object and to a workpiece, respectively, and to a laser machining system comprising the same.

### BACKGROUND OF THE INVENTION

In a system for material machining using lasers, i.e. in a laser machining system, the laser beam exiting from a laser light source or one end of a laser fiber is focused or collimated onto the workpiece to be machined using beam guidance and focusing optics. Typically, a laser machining head with collimator optics and focusing optics is used, with the laser light being supplied via an optical fiber. In laser material machining, an optical coherence tomography (OCT) device may be used to measure various process parameters, such as the distance to the workpiece, an edge position in advance, a weld depth during a welding process or a surface topography in the wake. A measuring light beam is directed to a desired position on the workpiece by a scanner device.

Optical coherence tomography (OCT) uses interference effects to determine distance differences with respect to a reference distance. The predefined reference distance of an OCT device determines the absolute distance to the object to be measured. At this distance, a measurement within a measuring range is possible. The measuring range of the OCT device is determined by the properties of the measuring light source used (e.g. a superluminescence diode) and the detector. Typically, the size of the measuring range is in the range of a few millimeters <20 mm. In other words, an OCT device measures the difference between the optical path length of a measuring arm and that of a reference arm in order to determine a distance.

In a so-called scanner laser machining system, the laser beam (i.e. the machining laser beam) may be directed to different positions on the workpiece using a scanner device. The scanner device usually comprises at least one scanning element, e.g. at least one scanning mirror that is pivotable about one or two axes in order to deflect the laser beam. In a scanner laser machining system, the optical path length (OWL) therefore changes with the deflection of the mirror. In order to be able to measure equally across the entire working or scanning area, this OWL change must be taken into account during the measurement, thus reducing the OCT measuring range that is effectively usable. In many cases, the increase in the optical path length is greater than the measuring range of the OCT. Aus a result, distance measurements are no longer possible, particularly at the edge of the scanning field. For this reason, the use of a plurality of reference sections with different lengths or different measuring ranges or the use of a reference section with variable length is necessary in order to be able to measure across the entire scanning range.

Known methods for increasing the measuring range of an OCT measuring system, for example as described in DE 10 2013 008 269 A1, are based on the synchronous adjustment of the optical path length in the reference arm. The adjustment is performed by mechanically changing the optical path length of the reference arm, e.g. by changing the position of an end mirror or prism on a linear axis. The disadvantages of these methods are due to the very complex control of the described mechanism. EP 3 830 515 B1 describes an OCT measuring system in which the reflected measuring light is simultaneously guided into a large number of reference sections of the reference arm.

These known methods use the one-sided measuring range of the OCT measuring system, i.e. a positive measuring range or a negative measuring range (i.e. either the positive or the negative solution of the Fourier transformation that outputs the distance signal). Here, for example, a pre-adjustment is used to determine which part of the measuring range is used so as to make the measurement unambiguous and to avoid the singularity at the 0 point. This results in the number of reference sections that are to cover the distance range ΔM: N=ΔM/Δm, where Δm is the maximum possible measuring range for a reference arm setting, i.e. of a reference section. Here, the maximum possible measuring range refers to the one-sided measuring range in which a recognizable measuring signal is detectable. The provision of a large ΔM, e.g. in a scanner laser machining system, means that many reference sections have to be set up. For use in a scanner laser machining system, a very large number of reference sections are therefore necessary or other expensive components have to be used, which leads to high manufacturing costs, large space requirements and high adjustment effort.

### SUMMARY OF THE INVENTION

It is an object of the present invention to provide an optical coherence tomography device for a laser machining system for measuring the distance to an object or a workpiece, said device having an extended measuring range or enabling better use of a measuring range, and a laser machining system comprising the same.

It is an object of the present invention to provide a cost-effective and compact optical coherence tomography device for a laser machining system for measuring the distance to an object or a workpiece, in particular having the largest possible measuring range and the smallest possible number of reference distances in a reference arm structure, and a laser machining system comprising the same.

It is an object of the present invention to provide a cost-effective and compact optical coherence tomography device for a laser machining system for measuring the distance to an object or a workpiece, said device in particular having a large measuring range and a compact reference arm structure, and a laser machining system comprising the same.

It is an object of the present invention to provide an optical coherence tomography device for a scanner laser machining system for measuring the distance to an object or a workpiece, said device being suitable for measuring large surfaces on which components or workpieces with different heights (due to assembly and manufacturing tolerances) are disposed, as well as a laser machining system comprising the same.

It is an object of the present invention to provide an optical coherence tomography device for a laser machining system for measuring the distance to an object or a workpiece, said device having a compact and passive reference arm structure in order to be able to measure components at a wide variety of positions, regardless of comparatively large height fluctuations due to mechanical tolerances, as well as a laser machining system comprising the same.

At least one of these objects is achieved by the subject matter disclosed herein.

The present invention is based on the idea of using a reference arm having a plurality of reference sections in an optical coherence tomography device for distance measurement during laser machining, wherein the number of reference sections required is reduced by a switching element or a controllable element (e.g. a motor or in particular an MEMS-based fiber switch) ensuring the switch between the individual reference sections, and by using both positive and negative measuring ranges of the reference sections. The sensor principle used here is optical short-coherence interferometry for distance measurement. In this disclosure, “distance” may also be referred to as “relative distance”.

As stated in the introduction, when measuring distances, conventionally no distinction is made as to which of the two arms has the longer optical path length since only the difference in length or the amount of the difference in length is measured. Since the positive measuring range and negative measuring range, in which the optical path length of the measuring arm or the optical path length of the reference arm is longer, cannot be distinguished, usually only one of the two ranges is used (e.g. in which the optical path length of the reference arm is shorter than that of the measuring arm). Thus, half of the theoretically available measuring range, i.e. where a distance measurement is physically possible, is not used. According to the invention, however, both the positive and the negative measuring ranges of a reference section are used for distance measurement by specifically switching or changing from a positive or negative measuring range of a reference section to a positive or negative measuring range of another reference section of the reference arm using a switching element. With the conventional reference arm structure using the one-sided measuring range, it is the case that as the distance (i.e. measuring distance or distance to be measured) increases, it is always necessary to switch to a longer reference section in order to compensate for this change in distance. According to the present invention, it is explicitly possible and advantageous to make switches to a shorter reference section as the measuring distance increases, i.e. the switches are made from the negative active measuring range of a longer reference section to the positive active measuring range of a shorter reference section. This allows for the number of reference sections required to be significantly reduced.

According to one aspect of the present invention, an optical coherence tomography device for a laser machining system for measuring the distance to an object or a workpiece comprises: a measuring arm for directing a measuring light beam at the object; a reference arm for guiding a reference beam with a plurality of reference sections having different measuring ranges or optical path lengths; and a controllable switching element for switching between the reference sections of the reference arm. The measuring range of each reference section comprises a negative active measuring range and a positive active measuring range, between which there is a dead zone. The dead zone of at least one of the reference sections is overlapped by a positive or negative active measuring range of at least one other reference section. The positive and negative active measuring ranges of the reference sections together cover a predetermined distance range. Thus, both the positive and the negative active measuring ranges of the reference sections are provided for distance measurement in the predetermined distance range.

The controllable switching element may be configured and/or connected to the reference sections so as to switch back and forth or change between the positive active measuring range of one of the reference sections and the negative active measuring range of another of the reference sections. In other words, the switching element may be connected to the reference sections so as to be able to switch to each of the positive and negative active measuring ranges of the reference sections.

The switching element is a controllable switching element, e.g. a motor-based switching element, an optical switch, a fiber switch, in particular an MEMS-based fiber switch, etc. Each reference section may be assigned to a position of the switching element. The reference sections may include or be fiber-bound reference sections and/or free-beam reference sections. The optical coherence tomography device may include a control for controlling the switching element. The control may be configured to switch back and forth between the positive active measuring range of one of the reference sections and the negative active measuring range of another of the reference sections by means of the switching element. In particular, the control may be configured to select a reference section with a positive active or negative active measuring range according to a predetermined or desired sub-range of the distance range and to switch to the selected reference section using the switching element. For this purpose, the control may be configured to receive a signal with information about the predetermined or desired sub-range of the distance range, e.g. from a control device of a laser machining system.

The optical coherence tomography device may be a device for optical distance measurement during laser material machining, i.e. during cutting, welding, stripping and additive LPBF (laser powder bed fusion) and LMD (laser material deposition) processes using laser beams.

The optical coherence tomography device may further comprise a measuring light source for generating measuring light, e.g. a superluminescence diode or a laser diode. The optical coherence tomography device may comprise an optical element for splitting the measuring light into the measuring light beam and the reference beam. The optical coherence tomography device may further comprise a detector for detecting an interference signal, i.e. for detecting interference effects between the measuring arm and the reference arm. The interference signal may be based on an interference between a portion of the measuring light beam reflected by the object and the reference beam or correspond to an optical path length difference between the measuring arm and the reference arm.

Each reference section of the reference arm may have a different measuring range or a different optical path length than the other reference sections. In other words, the measuring range of each reference section may correspond to a different distance value range. The measuring ranges of the reference sections may each be offset from one another by a predetermined amount and/or overlap. The measuring ranges of the reference sections may be the same size (but correspond to different distance value ranges). When the reference arm has N reference sections, an n-th reference section may be shorter (i.e. have a shorter optical path length or have a measuring range including smaller distance values) than an (n+1)-th reference section, where n, N are natural numbers with 1<N and 1≤n≤N. The first reference section may therefore also be referred to as the shortest reference section and/or the N-th reference section may be referred to as the longest reference distance.

The measuring range of each reference section, i.e. the theoretically available measuring range, includes a negative active measuring range and a positive active measuring range, i.e. a negative range and a positive range that can be used to measure distances. The measuring range of each reference section is split by the dead zone, which includes the singularity around zero and in which no measurement result can be obtained. The dead zone lies between the negative active measuring range and the positive active measuring range and may be directly adjacent thereto (i.e., in this case there is no tolerance range in between). A negative active measuring range of a reference section may correspond to smaller distance values than a positive active measuring range of the same reference section.

The positive and negative active measuring ranges of the reference sections together cover the predetermined distance range (in particular completely or without gaps). The device is therefore configured to measure in the entire predetermined distance range. In other words, the predetermined distance range refers to the range in which the device is to be configured to make distance measurements. For this purpose, the dead zone of at least one of the reference sections is overlapped by a positive or negative active measuring range of at least one other reference section.

The reference sections may include at least one reference section the negative active measuring range of which corresponds to larger distance values than a negative active measuring range of at least one other reference section and the negative active measuring range of which corresponds to smaller distance values than a positive active measuring range of said at least one other reference section. The positive and negative active measuring ranges of the reference sections may therefore be nested within one another. This means that a positive or negative active measuring range of another reference section may be arranged between the positive and negative active measuring range of a reference section. A partial range of the predetermined distance range that lies between the positive and negative active measuring ranges of a reference section may therefore be covered by a positive or negative active measuring range of another reference section.

The positive and negative active measuring ranges of the reference sections may be directly adjacent to one another, i.e. preferably none of the positive and negative active measuring ranges overlaps another of the positive and negative active measuring ranges. Each of the positive and negative active measuring ranges may be assigned to a different sub-range of the predetermined distance range. In particular, each negative active measuring range and each positive active measuring range may be unambiguously assigned to a sub-range of the predetermined distance range and/or each sub-range of the predetermined distance range may be unambiguously assigned to one of the negative and positive active measuring ranges. The sub-ranges of the predetermined distance range may be directly adjacent to one another, i.e. they do not overlap. The unambiguous assignment of the active measuring ranges to sub-ranges of the predetermined distance range allows for the optical coherence tomography device to be easily controlled.

At least one sub-range of the predetermined distance range may be assigned to a negative active measuring range of one of the reference arms and another or different sub-range of the predetermined distance range may be assigned to a positive active measuring range of the same reference arm. In other words, both active measuring ranges of this reference arm are used to measure the distance in the predetermined distance range.

The arrangement of the active measuring ranges (in particular an interconnection of the active measuring ranges) and/or the assignment of the active measuring ranges to sub-ranges of the predetermined distance range may be predetermined or preset. The assignment may be stored or saved (for example in the control of the optical coherence tomography device or in a control device of a laser machining system). The arrangement of the active measuring ranges (in particular an interconnection of the active measuring ranges) and/or the assignment of the active measuring ranges to sub-ranges of the predetermined distance range may be referred to as adjustment.

The reference arm may comprise N reference sections, where N is a natural number greater than 1. A negative active measuring range of an nth reference section may correspond to smaller distance values or include smaller distance values than a negative active measuring range of an (n+1)th reference section, where N is a natural number greater than 1 and n is a natural number with 1≤n≤N. A positive active measuring range of an nth reference section may correspond to smaller distance values or include smaller distance values than a positive active measuring range of an (n+1)th reference section, where N is a natural number greater than 1 and n is a natural number with 1≤n≤N.

A positive active measuring range of an nth reference section may correspond to larger distance values or include larger distance values than a negative active measuring range of an (n+1)th reference section. A positive active measuring range of the first (n=1) reference section (and/or each of the positive active measuring ranges) may correspond to or include larger distance values than each of the negative active measuring ranges of the N reference sections.

The reference sections may comprise at least one j-th reference section, the negative active measuring range of which is directly adjacent to a positive active measuring range of an i-th reference section, where i, j are natural numbers with 1≤i<j≤N. That is, the reference sections may comprise at least one j-th reference section, the negative active measuring range of which corresponds to a sub-range of the distance range that is directly adjacent to another sub-range of the distance range corresponding to a positive active measuring range of an i-th reference section, where i, j are natural numbers with 1≤i<j≤N. In other words, as the measuring distance increases, the switch is made from the negative active measuring range of the j-th reference section to the positive active measuring range of the i-th reference section, and vice versa as the measuring distance decreases, the switch is made from the positive active measuring range of the i-th reference section to the negative active measuring range of the j-th reference section. The j-th reference section may also be referred to as a switching reference section, in which the switch is made to a shorter (i.e. i<j) reference section as the measuring distance increases. In particular, the N-th reference section may be the switching reference section, i.e. j=N. The negative active measuring ranges of the first reference section, the second reference section, . . . of the j-th reference section, and subsequently the positive active measuring ranges of the first reference section, the second reference section, . . . of the j-th reference section may correspond to increasing distance values of the predetermined distance range in the specified order.

The reference arm may comprise K groups of reference sections, where K is a natural number with 1≤K. A measuring range of a (j+1)th group may correspond to or include larger distance values than a measuring range of a jth group, where j is a natural number with 1≤j≤K. Each group may include the same number M of reference sections, i.e. K*M=N. Each group of reference sections may include (exactly) one switching reference section. The groups preferably complement each other such that the complete distance range is covered.

The reference arm may comprise at least one group of M reference sections, where M is a natural number with 1≤M≤N. The reference arm may in particular comprise a plurality of groups of reference sections, where the groups comprise the same or a different number of reference sections. For example, the reference arm may comprise a first reference section or a first group with only one reference section and at least one group with a plurality of (e.g. two, three, . . . ) reference sections. The negative active measuring ranges of the (M−m) other reference sections of the group and/or the positive active measuring ranges of the (m−1) other reference sections of the group may be arranged between a negative active measuring range and a positive active measuring range of an m-th reference section, where m is a natural number with 1≤m≤M. This means that the negative active measuring ranges of the (M−m) other reference sections (i.e. the (m+1)-th, . . . . M-th reference sections) and/or the (m−1) positive active measuring ranges of the first, . . . (m−1)-th other reference sections may be arranged between the negative active measuring range and the positive active measuring range of the m-th reference section. A positive active measuring range of the first (m=1) reference section of the group (and/or each of the positive active measuring ranges of the M reference sections of the group) may correspond to larger distance values or include larger distance values than each of the negative active measuring ranges of the M reference sections of the group. A positive active measuring range of an m-th reference section of the group may correspond to smaller distance values or include smaller distance values than a positive active measuring range of an (m+1)-th reference section. Accordingly, the negative active measuring range of an m-th reference section of the group may correspond to smaller distance values or include smaller distance values than the negative active measuring range of an (m+1)-th reference section. The negative active measuring ranges of the first reference section, the second reference section, . . . the m-th reference section, the (m+1)-th reference section, . . . the n-th reference section and subsequently the positive active measuring ranges of the first reference section, the second reference section, . . . the m-th reference section, the (m+1)-th reference section, . . . the M-th reference section may correspond to increasing distance values of the predetermined distance range in the specified order.

The measuring range of each reference section may have a positive tolerance range that borders on one or both sides of the positive active measuring range of this reference section and/or a negative tolerance range that borders on one or both sides of the negative active measuring range of this reference section. The dead zone may be arranged between the negative and positive tolerance ranges. The negative and positive tolerance ranges of each reference section may be separated from each other by the dead zone. The positive and/or negative tolerance range may ensure that a measurement in the respective measuring range is possible despite a component tolerance or mechanical tolerance.

In other words, the measuring range of each reference section may comprise at least one of the following ranges: a lower negative tolerance range that borders on a lower end of the negative active measuring range and corresponds to smaller distance values than the negative active measuring range; and/or an upper negative tolerance range that borders on an upper end of the negative active measuring range and corresponds to larger distance values than the negative active measuring range; and/or a lower positive tolerance range that borders on a lower end of the positive active measuring range and corresponds to smaller distance values than the positive active measuring range; and/or an upper positive tolerance range that borders on an upper end of the positive active measuring range and corresponds to larger distance values than the positive active measuring range. The dead zone may be arranged between the upper negative and lower positive tolerance ranges. This means that an upper negative tolerance range, the dead zone and a lower positive tolerance range may lie between the negative active measuring range and the positive active measuring range of a reference section. The upper negative tolerance range and the lower positive tolerance range may be adjacent to the dead zone or the dead band may be located between the upper negative tolerance range and the lower positive tolerance range. The negative tolerance range may include the lower negative tolerance range and/or the upper negative tolerance range. The positive tolerance range may include the lower positive tolerance range and/or the upper positive tolerance range.

The positive and/or negative tolerance range of a reference section may be overlapped by a negative or positive active measuring range of at least one other reference section. In particular, the entirety of all tolerance ranges of all reference sections may be completely overlapped or covered by active measuring ranges of the reference sections.

According to one aspect of the present disclosure, a laser machining system comprises a laser machining head, an optical coherence tomography device for a laser machining system for measuring distance to an object or to a workpiece according to one of the embodiments described herein, and a control device for controlling the laser machining system, in particular the laser machining head, and the optical coherence tomography device, in particular the switching element of the optical coherence tomography device. The control device may therefore comprise the control of the optical coherence tomography device.

The control device or the control of the optical coherence tomography device may be configured to switch to a shorter reference section as the distance increases, i.e. to a reference section with a measuring range that has smaller distance values (than the measuring range of the previous reference section). This means that the control device or the control of the optical coherence tomography device may be configured to switch or change from a reference section to a shorter reference section as the distance from an object or workpiece increases. In other words, the control device or the control of the optical coherence tomography device may be configured to switch or change from a j-th reference section to an i-th reference section as the distance increases, wherein the reference arm has N reference sections and i, j are natural numbers with 1≤i<j≤N and an i-th reference section is shorter (i.e. has a shorter optical path length or has a measuring range that includes smaller distance values) than an (i+1)-th reference section. In particular, the control device or the control of the optical coherence tomography device may be configured to switch from a negative active measuring range of a j-th reference section to a positive active measuring range of an i-th reference section as the distance increases.

The laser machining head may comprise a scanner device with at least one scanning element for deflecting a laser beam to a plurality of positions on a workpiece. The control device may be configured to control the scanner device. A beam path of the measuring light beam of the optical coherence tomography device may be coupled into a beam path of the laser beam upstream of the scanner device (i.e. before the scanner device in the propagation direction of the laser beam). In other words, a beam path of the measuring light beam of the optical coherence tomography device may extend over/via the scanner device.

The control device or the control of the optical coherence tomography device may be, for example, a PC or a computing unit. The control device or the control of the optical coherence tomography device may be configured to switch back and forth between the reference sections using the switching element, for example between a positive active measuring range of a reference section and a negative active measuring range of another reference section.

The control device or the control of the optical coherence tomography device may be configured to switch back and forth between the reference distances or to select a reference distance using the switching element depending on a setting or position of the scanning element. The control device or the control of the optical coherence tomography device may be configured to select one of the reference sections for distance measurement in accordance with a scan command for adjusting the scanning element of the scanner device. In one example, the control device may be configured to control the scanner device using a scan command or to adjust the scanning element using a scan command, e.g. to direct the laser beam to a specific position on the workpiece. The control device or the control of the optical coherence tomography device may be further configured to select one of the reference distances or to switch to one of the reference distances based on the scan command. However, the scanner device may also be configured or controlled by another unit using a scan command. The control device or the control of the optical coherence tomography device may be configured to switch from a negative measuring range of longer reference section to a positive measuring range of another, shorter reference section when the optical path length increases due to a change in position of the scanning element.

The laser machining system and/or the optical coherence tomography device may comprise an evaluation device for determining the distance based on an interference between a portion of the measuring light beam reflected by the object and the reference beam, in particular based on an interference signal from the detector. The evaluation device may be included in the control device of the laser machining system or in the control of the optical coherence tomography device. The optical coherence tomography device may further comprise an optical combiner for superimposing the portion of the measuring light beam reflected by the object and the reference beam for interferometric determination of the distance of the object. The optical combiner may also be the beam splitter.

A zero position of the scanning element, i.e. a position without deflection or a position in which the laser beam extends in parallel or coaxially to the optical axis of the focusing optics through the same, may correspond to the smallest distance value of the predetermined distance range or lie in the negative (or positive) active measuring range of the first (or shortest) reference distance of the reference arm. A relation between a change in the position of the scanning element with respect to the zero position and a resulting change in the distance to the object or workpiece may be stored or saved in the control device or in the control of the optical coherence tomography device and/or in the evaluation device. Additionally or alternatively, an offset value may be stored or saved in the control device or in the control of the optical coherence tomography device and/or in the evaluation device for each reference distance. The offset value may be taken into account by the evaluation device when determining the distance.

The evaluation device may be configured to determine the distance based on a setting of the scanning element (e.g. the scan command) or based on scanner data regarding the position of the laser beam or the measuring light beam in the working region and based on the interference signal of the detector or based on an interference between a portion of the measuring light beam reflected by the object and the reference beam, i.e. based on a superposition of a portion of the measuring light beam from the measuring arm reflected by the object and the reference beam from the correspondingly selected reference arm (or from the selected or activated reference section of the reference arm).

The control device may be configured to determine an alignment (in particular an inclination and/or three-dimensional orientation) of the laser machining head with respect to the workpiece based on distance values that were determined by the optical coherence tomography device during a scan of the measuring light beam over the workpiece by means of the scanner device. Scanning may be performed over an entire scan area of the scanner device, e.g. as a linear scan or cross scan or spiral scan or as a meandering scan. When, for example, a position of the laser beam or the measuring light beam on the workpiece is specified in Cartesian coordinates (e.g. with an origin corresponding to the zero position), an x-coordinate may be moved from 0 to a maximum value+xmax, or from −xmax to +xmax for scanning. Additionally or alternatively, a y-coordinate may be moved from 0 to a maximum value +ymax, or from −ymax to +ymax for scanning.

The control device may be configured to assign reference height values, which have been recorded, for example, during calibration in a predetermined or desired working plane or reference plane, to the corresponding positions in the scan area or scan field of the scanner device. The reference height values may also be referred to as calibration data. The control device may be configured to determine a relative distance (for example with respect to a reference plane, e.g. the working plane) to the workpiece to be machined for a given scanner position by using the data from the calibration and from the measurement on the workpiece at this scanner position. The control device may be configured to determine an actual or absolute distance to the workpiece to be machined for a given scanner position by using the data from the calibration (or the difference to the reference plane) and the measurement on the workpiece at this scanner position. The measurement may be point-by-point, may traverse a path (line, cross, circle, spiral, etc.), or may be a scan of an area.

In one embodiment, the following steps may be carried out in a method for setting up the device in a laser machining system: defining a reference plane (e.g. the working plane) of the laser machining system, and calibrating the optical coherence tomography device by assigning reference height values to the corresponding positions in the scan area. The reference plane or working plane of the laser machining system may be the plane to which the laser machining system is aligned, for example the focal plane of an objective or a focusing optics of the laser machining system. During calibration, a reference height value may be assigned to each position on the reference plane in the scan area in order to determine a difference between a measured value at this position and the actual height value, i.e. an offset. When measuring the object or workpiece, a deviation from the reference plane and/or a (relative or absolute) distance may be determined by taking into account the measured value and the calibration data for the respective (measuring) position in the scan field.

The control device may be configured to adjust machining parameters (e.g. welding parameters, in particular the collimation of the hot beam, laser power, focal position, etc.) based on the measurement carried out or based on the determined distance, in particular before laser machining at this point or at this scan position. The control device may be configured to adjust system parameters (focusing of a camera, scaling of image data, etc.) based on the measurement or based on the determined distance.

Due to opto-mechanical properties of the scanner system, a deflection of at least one scan element, e.g. of scanner mirrors, may cause a change in the optical path length to the target plane, i.e. a change in the distance. This may make it necessary to calibrate the measurement signal or OCT signal or the distance value as a function of the deflection (lateral position) or the scan position. Thus, a calibration of the OCT device for the laser machining system or for the scanner device may be stored or saved in the control device of the laser machining system and/or in the control of the optical coherence tomography device. Additionally or alternatively, a model for a change in the optical path length or distance as a function of the scan position for the laser machining system or for the scanner device may be stored or saved in the control device of the laser machining system and/or in the control of the optical coherence tomography device. This makes it possible to assign the reference distances to sub-ranges in the scanning area or in the predetermined distance range. Furthermore, various parameters of the overall system may be determined.

In the present disclosure, the working or scanning area refers to an area into which the laser beam or the measuring light beam can be directed by means of the scanner device with respect to the laser machining head. The predetermined distance range refers to a range from the smallest distance value that can be measured using the optical coherence tomography device to the largest distance value that can be measured using the optical coherence tomography device. Preferably, the position of the scanning element at which the laser beam is not deflected (so-called zero position of the scanning element) corresponds to an origin of a polar coordinate system. A change in the optical path length that is based on a change in the position of the scanning element may be represented as a radial length. The zero position of the scanning element, i.e. the position or setting at which the laser beam is not deflected, may correspond to a shortest optical path length, i.e. a shortest distance to the workpiece or to an object. The control device or the control of the optical coherence tomography device can be configured to set the first or shortest reference distance at the zero position of the scanning element or to switch to the first or shortest reference distance. The predetermined distance range may correspond to at least part of a range of the optical path length change that can be achieved by changing the position of the scanning element.

The laser machining head may further include a focusing optics, in particular an F-Theta lens, for focusing the laser beam and/or the measuring light beam. The focusing optics may be arranged downstream of the scanner device (with respect to the beam propagation direction of the laser beam).

The laser machining head may be a laser machining head for carrying out a machining process, in particular for laser cutting, laser welding, laser soldering, laser drilling, etc., on the workpiece by means of the laser beam.

The workpiece can be a metallic workpiece in particular. The laser machining system or the laser machining head may be configured to process a metallic workpiece. The object can be the workpiece.

### BRIEF DESCRIPTION OF THE DRAWINGS

Embodiments of the disclosure are shown in the Figures and are described in more detail below. In the Figures:

FIG. 1 shows an optical coherence tomography device according to an embodiment of the present invention;

FIG. 2A schematically shows a conventionally used measuring range of a reference section and FIG. 2B shows a conventional structure of a reference arm with a plurality of reference sections;

FIG. 3 schematically shows a measuring range of a reference section used according to the invention;

FIG. 4 shows a structure of a reference arm with a plurality of reference sections according to an embodiment of the present invention;

FIG. 5 schematically shows a structure of a measuring range of a reference section with negative and positive tolerance ranges according to an embodiment of the present invention;

FIGS. 6A and 6B each show a structure of a reference arm with a plurality of reference sections according to embodiments of the present invention;

FIG. 7 shows a laser machining system with an optical coherence tomography device according to an embodiment of the present invention;

FIGS. 8A and 8B illustrate situations during laser machining using a scanner laser machining head;

FIG. 9 shows a calculation for a possible course of an OCT distance measurement with four reference sections;

FIG. 10 illustrates complex offsets in the measurement signal with various dependencies, in particular on a scan position;

FIG. 11 shows a division of a scan area into switch positions of the switching element; and

FIG. 12 shows a positioning error of a calibration plate, e.g. when the workpiece rests at an angle.

### DETAILED DESCRIPTION OF THE INVENTION

In the following, unless otherwise stated, the same reference symbols are used for identical and equivalently acting elements.

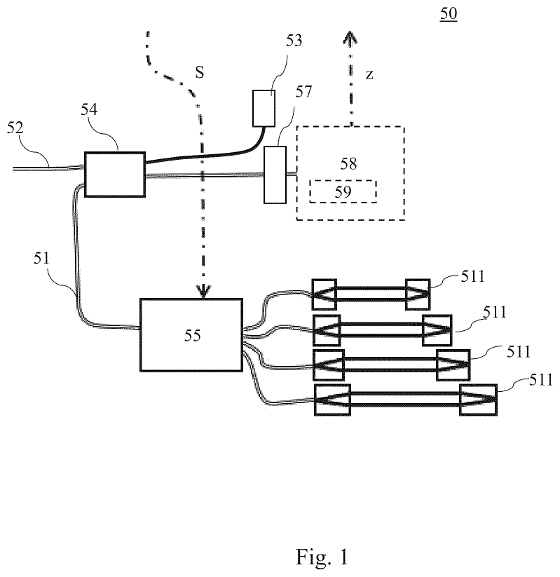

FIG. 1 shows an optical coherence tomography device 50, hereinafter also referred to as OCT device, according to an embodiment of the present invention. The OCT device 50 is configured to measure distances to an object, for example a workpiece surface or a component, in a predetermined distance range O. The OCT device 50 comprises a measuring arm 52 for radiating a measuring light beam onto the object or for guiding measuring light reflected from the object and a reference arm 51 for guiding the reference beam, wherein the reference arm 51 comprises two or more reference sections 511 with different optical path lengths, i.e. with different measuring ranges MB. The OCT device 50 includes a detector 57 configured to detect an interference signal. Furthermore, a controllable switching element 55 is provided for switching between the reference sections 511 of the reference arm 51. The switching element 55 may comprise a fiber switch, a MEMS-based switching element, Beckhoff I/O terminals, etc. Based on a switching signal S, the switching element 55 may select one of the reference sections 511, i.e. turn it active for the distance measurement or direct the reference beam into this reference section. Optionally, the OCT device 50 may comprise an OCT processor 58, which may also be referred to as the control of the OCT device 50. The OCT processor 58 may comprise an evaluation unit. The detector 57 may be connected to the OCT processor 58 or to the evaluation unit in order to supply the interference signal thereto. The OCT processor 58 may, for example, be configured to output an OCT signal or measurement signal or a distance value z based on a predetermined offset of the selected reference section 511 and based on a superposition or interference between the portion of the measurement light beam from the measurement arm 52 reflected by the object and the reference beam from the reference arm 51. Alternatively or additionally, the OCT processor 58 may be configured to output the switching signal S to the switching element 55 in order to set a specific reference section 511. The OCT processor 58 (possibly with the evaluation unit) may be provided separately or integrated into a control of a laser machining system or a laser machining head.

The OCT device 50 further comprises a measuring light source 53 for generating measuring light and an optical element 54 for splitting the measuring light into the reference beam and the measuring light beam. The optical element 54 may comprise or be at least one beam splitter, fiber coupler, prism, etc.

The OCT device 50 may further comprise an evaluation unit 59 configured to determine the distance based on a superposition of a portion of the measuring light beam 525 from the measuring arm 52 reflected by the workpiece or component and the reference beam from the reference arm 51, as well as based on the switching position or on the selected reference section 511. As shown in FIG. 1, the evaluation unit 59 may be integrated into the OCT control 58, but is not limited thereto. The detector 57 may be connected to the evaluation unit 59 in order to supply the interference signal thereto.

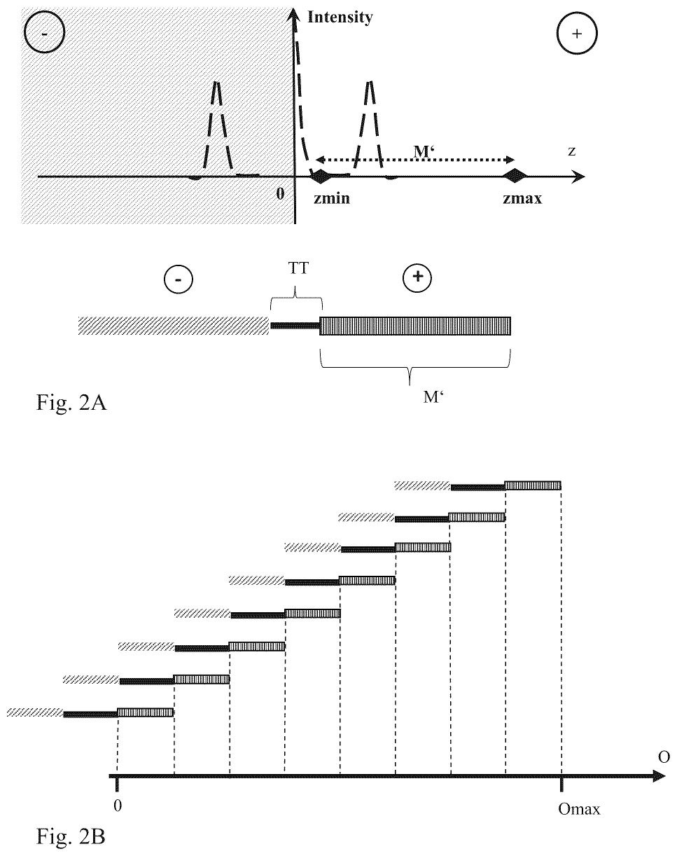

FIG. 2A illustrates a conventionally used measuring range M′ of a reference arm or a reference section. As a rule, an OCT device measures a distance difference between the optical path length of the measuring arm and that of the reference arm. The optical path length of the measuring arm may, for example, correspond to a distance to an object or to a component or to a workpiece surface or to a working plane. A “negative” measuring range is present when the reference arm is longer than the measuring arm, and a “positive” measuring range is present when the reference arm is shorter than the measuring arm. These parts of the measuring range cannot be distinguished after a Fourier transformation, which is generally carried out to evaluate the OCT signal, and cannot be mapped by the OCT processor. The OCT signal or the distance value z may therefore correspond to two possible values: z=|RL−ML|, with RL: optical path length of the reference arm and ML: optical path length of the measuring arm (i.e. distance to the object). In order to ensure an unambiguous measurement, conventionally only a one-sided (e.g. the positive) measuring range is used for distance measurement, i.e. the hatched (e.g. negative) range does not exist and only schematically maps the symmetry around the zero point. There is also the problem around the zero point that if the difference is zero, there is a singularity in the signal and therefore the range around zero is not available as a measuring range. This range is also referred to as the dead zone TT and lies between the negative and positive parts of the measuring range. Thus, in the known OCT devices, the active or usable measuring range M′ is defined as the range in the positive (or negative) measuring range in which a signal or a peak can be recognized. The limits of the active measuring range M′ are given in FIG. 2A as zₘᵢₙ and zₘₐₓ.

FIG. 2B illustrates a conventional structure of a reference arm with a plurality of reference sections. In the known OCT devices, the active measuring ranges M′ of the reference sections are arranged adjacent to one another in order to cover a predetermined distance range O. As explained above, either the positive or the negative parts of the measuring ranges are used as active measuring ranges M′.

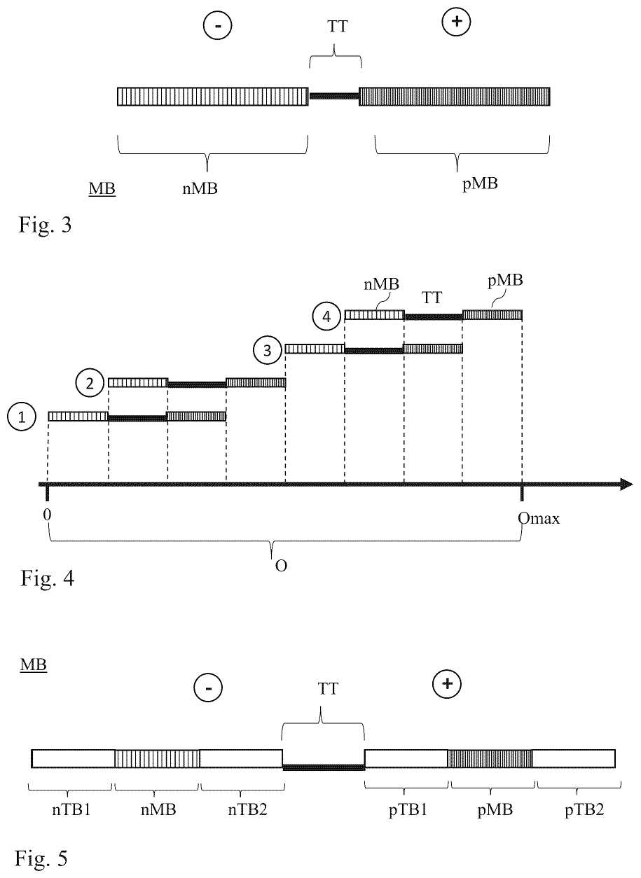

FIG. 3 illustrates the measuring range MB of a reference section 511 according to an embodiment of the present invention. The measuring range MB, i.e. the range in which a distance signal or a peak can be recognized, comprises both a negative active measuring range nMB and a positive active measuring range pMB, which together may be referred to as the active measuring range aMB. Between the negative active measuring range nMB and the positive active measuring range pMB is the dead zone TT in which no signal or peak can be recognized. In the embodiment shown here, the negative active measuring range nMB and the positive active measuring range pMB may be directly adjacent to the dead zone TT.

FIG. 4 shows a structure of a reference arm 51 of an OCT device 50 according to an embodiment of the present invention. The dead zones TT of each reference section 511 are covered or overlapped by a negative or positive active measuring range nMB or pMB of another reference section 511. This enables a seamless measurement in the predetermined distance range O, i.e. from 0 to Omax. The numbering of the reference sections 511 may correspond to switch settings or switching positions of the switching element 55. The reference sections 511 are arranged according to their optical length, i.e. a measuring range MB of reference section 1 includes smaller distance values than a measuring range MB of reference section 2, which in turn includes smaller distance values than a measuring range MB of reference section 3, which in turn includes smaller distance values than a measuring range MB of reference section 4. In other words, a measuring range MB of reference section 4 corresponds to larger distance values than a measuring range MB of reference section 3, which in turn corresponds to larger distance values than a measuring range MB of reference section 2, which in turn corresponds to larger distance values than a measuring range MB of reference section 1. In particular, a negative active measuring range nMB of reference section 1 includes smaller distance values than a negative active measuring range nMB of reference section 2, which in turn includes smaller distance values than a negative active measuring range nMB of reference section 3, which in turn includes smaller distance values than a negative active measuring range nMB of reference section 4. Accordingly, a positive active measuring range pMB of reference section 1 includes smaller distance values than a positive active measuring range pMB of reference section 2, which in turn includes smaller distance values than a positive active measuring range pMB of reference section 3, which in turn includes smaller distance values than a positive active measuring range pMB of reference section 4.

In the example shown in FIG. 4, two groups are shown, each with two reference sections 1 and 2 or 3 and 4, wherein the dead zone TT of each reference section of a group is overlapped by a negative active measuring range nMB or positive active measuring range pMB of another reference section 511 of the same group. The measuring ranges of the groups are adjacent to one another. In other words, a positive active measuring range pMB of the longest reference section (here reference section 2) of the first group is directly adjacent to the negative active measuring range nMB of the shortest reference section (here reference section 3) of the second group. Of course, only one group or more than two groups, and/or more than two reference sections per group may be used to cover the predetermined distance range O. In this case, the negative active measuring ranges nMB of the reference sections of a group are arranged directly subsequently and the positive active measuring ranges pMB of the reference sections of a group are arranged directly subsequently. Each group may comprise at least one reference section the negative active measuring range nMB of which is directly adjacent to a positive active measuring range pMB of another reference section of said group.

As the distance increases, the switch is first made from reference section 1 to reference section 2 in order to use the negative active measuring range nMB of these reference sections. As the distance increases further, the switch is made from reference section 2 back to reference section 1 in order to first use the positive active measuring range pMB of reference section 1 and, as the distance increases further, the positive active measuring range pMB of reference section 2. The switch is then made to reference section 3 of the second group in order to use the negative active measuring range nMB of the same, etc. According to the present invention, the switching element 55 is therefore configured to switch to a shorter reference section as the distance increases in order to use the positive active measuring range pMB thereof.

As explained above, the problem with an OCT measuring principle is that when the difference in the optical path lengths is zero (i.e. when the optical path of the reference arm and that of the measuring arm are equal), a singularity occurs in the signal and therefore the measuring range around zero is not available for a measurement (“dead zone”). This range is bridged by switching to another reference distance, thereby allowing for continuous measurement within the predetermined distance range.

FIG. 5 illustrates the measuring range MB of a reference section 511 according to another embodiment of the present invention. In addition to the negative active measuring range nMB and the positive active measuring range pMB, the measuring range MB comprises a negative tolerance range nTB, which borders on at least one end of the negative active measuring range nMB, and a positive tolerance range pTB, which borders on at least one end of the positive active measuring range pMB. The negative tolerance range nTB may comprise a lower negative tolerance range nTB1, which borders on a lower end of the negative active measuring range nMB, and/or an upper negative tolerance range nTB2, which borders on an upper end of the negative active measuring range nMB or which is arranged between the negative active measuring range nMB and the dead zone TT. Likewise, the positive tolerance range pTB may comprise a lower positive tolerance range pTB1, which is adjacent to a lower end of the positive active measuring range pMB or which is arranged between the dead zone TT and the positive active measuring range pMB, and/or an upper positive tolerance range pTB2, which is adjacent to an upper end of the positive active measuring range pMB.

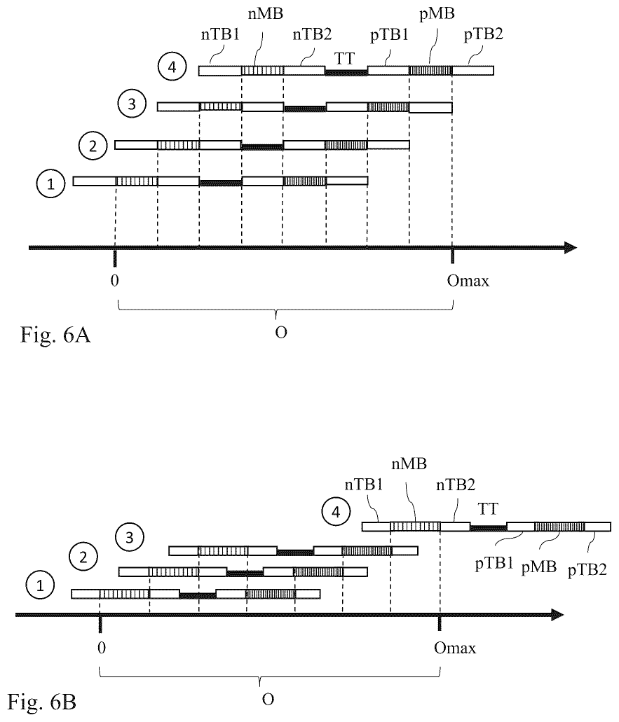

FIGS. 6A and 6B show a structure of a reference arm 51 of an OCT device 50 according to further embodiments of the present invention. In FIG. 6A, the reference arm 51 includes a plurality of reference sections 511 with the configuration shown in FIG. 5. The plurality of reference sections 511 form a group. The negative and positive active measuring ranges nMB and pMB are each sandwiched by negative and positive tolerance ranges nTB1, nTB2 and pTB1, pTB2, respectively. The dead zone TT is arranged between an upper negative tolerance range nTB2 and a lower positive tolerance range pTB1. In this example, too, the negative and positive active measuring ranges nMB and pMB of the reference sections 511 cover the measuring range O without gaps. At least the tolerance ranges of each reference section 511 adjacent to the dead zone TT, i.e. the upper negative tolerance range nTB2 and the lower positive tolerance range pTB1, are covered or overlapped by negative or positive active measuring ranges nMB and pMB of at least one other reference section 511. The absolute length of at least one of these tolerance ranges, nTB1, nTB2, pTB1, pTB2 may correspond to an expected or predetermined component tolerance or mechanical tolerance Δt. These so-called component tolerances Δt may be, for example, +/−0.25 mm to +/−5 mm. FIG. 6B also shows a reference arm 51 with four reference sections 1, . . . , 4 (N=4). However, the reference sections in FIG. 6B are arranged in two groups (K=2) of reference sections, the first group (k=1) comprising three reference sections (M1=3) and the second group (k=2) comprising a single reference section (M2=1). In this embodiment, the positive active measuring range pMB of the reference section 4 is not used. Even if the single reference section 4 is arranged according to the end of the measuring range O that corresponds to the largest values, a single reference section may be additionally or alternatively arranged according to the start of the measuring range O that corresponds to the smallest values (i.e. as the first reference section of the reference arm).

In this way, a further problem when a component of unknown height is to be measured near the dead zone can be solved: It cannot be unambiguously determined which measuring range is currently active, and thus it is unclear whether the current measuring section is smaller or larger than the reference section. This problem can be solved by reducing the measuring range: With the tolerance ranges, measuring ranges were reserved for the height measurement of components and the possibility of confusion was thus reduced, or at each position (x; y) a unique height position of the component can be determined for given component tolerances Δt.

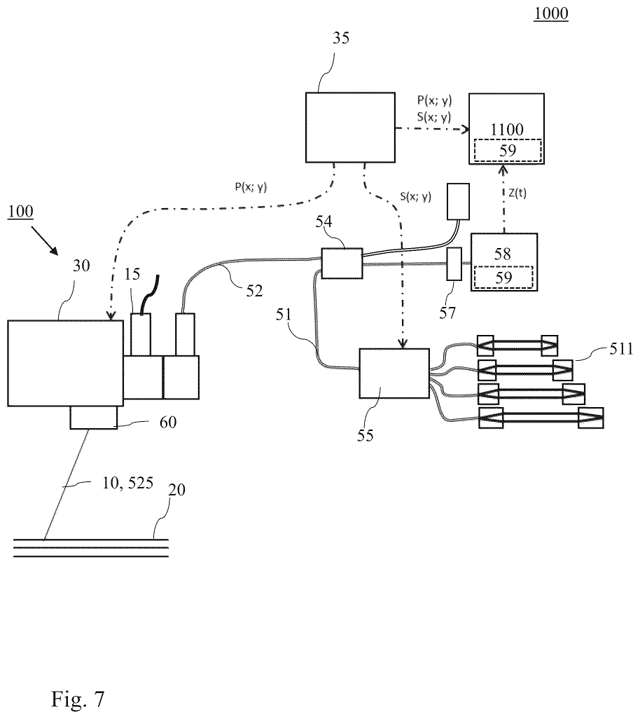

FIG. 7 shows a laser machining system 1000 with an OCT device 50 according to one of the embodiments described herein. The OCT device 50 may in particular have a structure as described with reference to FIG. 1. The laser machining system 1000 comprises a laser machining head 100, which comprises a scanner device 30 with a scanning element (not shown). The scanner device 30 is configured to direct the laser beam 10 or the measuring light beam 525 of the OCT device 50 at different positions on the workpiece 20. The beam path of the measuring arm 52 may be coupled into the beam path of the laser beam upstream of the scanner device 30 in the beam propagation direction, e.g. by means of a semi-transparent mirror or a beam splitter. In order to couple a laser beam into the laser machining head 100, a laser port 15, for example a fiber socket, may be provided. The laser machining head 100 may further comprise focusing optics 60, for example an F-Theta lens, in order to focus the laser beam 10 or the measuring light beam 525. The laser machining system comprises a control device 1100, also called a system control. The OCT control 58 may be integrated into the control device 1100 or provided separately. In any case, the OCT control 58 is connected to the control device 1100 for unidirectional or bidirectional data exchange. The OCT control 58 may transmit a measurement signal or distance value z (t) to the control device 1100. Furthermore, a scanner control 35 may be provided separately or integrated into the control device 1100, said scanner control 35 being connected to the control device 1100 and/or the OCT control 58 for unidirectional or bidirectional data exchange. The scanner control 35 issues a scan command P (x; y) to the scanner device 30 in order to direct the laser beam 10 or the measuring light beam 525 at a desired position using the scanning element.

The OCT control 58 and/or the scanner control 35 and/or the control device 1100 may be configured to select one of the reference sections 511 for distance measurement in accordance with a scan command P (x; y) for adjusting the scanning element of the scanner device 30 and to transmit a corresponding switching command S (x; y) to the switching element 55. The zero position P (x=0; y=0) of the scanner device 30 may be defined as the zero point of a polar coordinate system. The zero position may correspond to the minimum optical path length or the smallest value of the predetermined distance range O and is marked with 0 in FIGS. 4 and 6. The predetermined distance range O in which the OCT device is configured for distance measurement may correspond to a scan area of the scanner device 30. The scan area of the scanner device 30 may be, for example, 400 mm×335 mm or 320 mm×320 mm, or 280 mm×175 mm, or 185 mm×120 mm, or 280 mm×175 mm, or 185 mm×120 mm. In other words, the predetermined distance range O may correspond to a possible change in the optical path length due to a deflection by the scanning element. In this way, during laser machining by a scanner laser machining system 1000, a suitable reference section 511 of the reference arm 51 may be selected according to a change in the optical path length due to the deflection of the measuring light beam 525 by the scanner device 35, so that a distance measurement to an object or component is possible at this scan position.

The OCT device 50 and/or the laser machining system 1000 may further comprise an evaluation unit 59 configured to determine the distance based on the scan command P (x; y) or based on information regarding the position (x; y) in the scan area and based on a superposition of a reflected portion of the measuring light beam 525 from the measuring arm 52 and the reference beam from the correspondingly selected reference section 511 of the reference arm 51. The evaluation unit 59 may be integrated into the OCT control 50 and/or into the control device 1100.

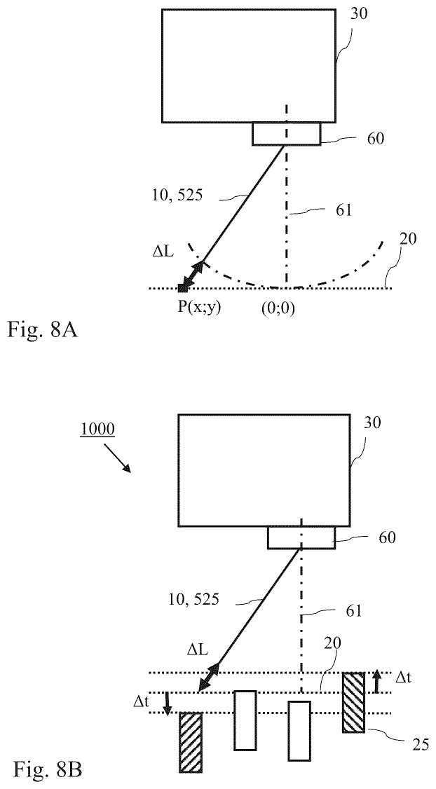

FIGS. 8A and 8B illustrate the problem of changing the optical path length as a function of the scan position P (x; y). The optical path length changes with the change in position of the scan element. For example, the surface of the workpiece 20 may be assumed to be planar and defines the working plane for the laser machining process. A deflection of the measuring light beam 525 to a position (x; y) leads to a change in length of ΔL with respect to the zero position (0; 0). For a scan area or for a scan field of 400 mm×300 mm, the change in optical path length with respect to the zero position may be, for example, 31 mm. With a component tolerance or mechanical tolerance of +/−10 mm, the measurement range to be covered is 51 mm. The maximum value of the distance measurement range O should therefore be at least 51 mm. The optical axis 61 of the focusing optics 60 is also indicated and coincides with the beam path at the zero position.

The OCT device 50 may have a reference section structure according to FIG. 3 or 5 and/or a reference arm structure according to FIG. 4 or 6. In order to ensure that a distance to a component 25 arranged on or at the workpiece surface can be measured in the entire predetermined distance range O, the reference section structure from FIG. 5 may be used, wherein the negative active measuring range nMB borders on a lower and/or upper negative tolerance range nTB1, nTB2 and the positive active measuring range pMB borders on a lower and/or upper positive tolerance range pTB1, pTB2. In this way, it can be ensured that a component height measurement (at least in the range of the component tolerance Δt) is possible with a switching position selected according to the scan position or with a reference section selected according to the scan position. By reducing the active measuring range by the tolerance range, the unambiguous measurement of the component height can be ensured in the entire scan area. In other words, the active measuring range aMB (i.e. nMB, pMB) may be used to compensate for the scan position-dependent path length change or distance change in order to subsequently determine the component height within the specified tolerance limits +/−Δt at the scan position.

The following explains, by way of example, how the OCT device 50 or the reference arm 51 of the OCT device according to an embodiment of the present invention may be constructed. First, a relationship between the deflection or position change of the scan element (e.g. a scanner mirror) and the change in the optical path length (OWL) or the distance to a working/reference plane or (e.g. planar) workpiece surface 20 is determined-either experimentally during calibration or by simulation (see FIGS. 8A and 8B). The resulting scan position-dependent optical path length change must then be split between the active measuring ranges of the reference arm 51 of the OCT device. The exact distances between the individual reference sections 511 result from specified component tolerances Δt, by which a height position of a component may deviate, as well as from minimum and maximum measurable values of the OCT device 50, i.e. from the distance range O that can be measured by the OCT device. The reference sections 511 are now adjusted such that the resulting active measuring ranges nMB, pMB complement each other. The active measuring ranges nMB, pMB of the reference sections thus cover the predetermined distance range O or the optical path length change in the entire scan area. Each reference section is assigned a position of the switching element 55 such that switching to one or the other reference section can be done as a function of the scan position or the scan command.

Hereinafter, an example of such an adjustment is described in more detail: First, the reference sections are adjusted such that a signal in the negative measuring range nMB can be measured in at least one of the reference sections 511 (or all of them) in the working plane in the scan area. The actual reference sections are set iteratively, for example, using a switching module, e.g. the switching element 55, and the mechanical position adjustment of end mirrors of the respective reference sections 511 in the reference arm 51. For the sake of simplicity, the indices of the reference sections may correspond to the positions of the switching element. The following applies to the reference distances themselves: The length of the i-th reference distance is smaller than the length of the (i+1)-th reference distance, i.e. RS_i<RS_i+1. In other words, the measuring range MB of the i-th reference distance corresponds to smaller distance values than the measuring range MB of the (i+1)-th reference distance.

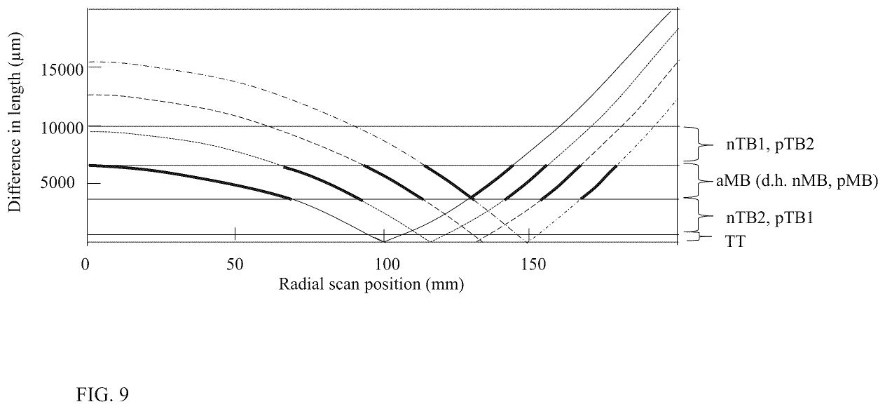

The first reference distance is then set to the position with the shortest optical path length OWL (x; y) or with the shortest distance so that the measurement signal is in the negative active measurement range nMB, in particular at an outer edge thereof (see FIGS. 4, 6 and 9). FIG. 9 shows a calculation for a possible course of a distance measurement for a scan position from 0 to 200 mm, e.g. the radial coordinate r is changed from 0 mm to 200 mm. The four curves represent four reference sections and correspond to an OWL change when measuring an idealized planar surface that is arranged in parallel to the scanner plane. The active measurement ranges on each curve are highlighted. In addition, the assumption is made that the optical scanner system is radially symmetrical. This means that, at the scan position (x=0; y=0), i.e. at the zero position, the measuring light beam is perpendicular to said surface (i.e. inclination is zero). The curves have vertical offsets I_o of 6500, 9500, 12500 and 15500 μm (with an idealized quadratic curve and curvature k=0.7). Due to the different vertical offsets I_o, the curves are shifted and come into the (positive or negative) active measuring range nMB, pMB (i.e. the “available measuring range”) at respectively different scan positions. The negative and positive active measuring ranges located to the left and right of the reversal point at “length difference=0” may also be seen in the profile of the respective curve. To the left of the reversal point, i.e. in the negative active measuring range nMB, the reference section 511 is longer than the measuring distance, to the right of it, i.e. in the positive active measuring range pMB, it is shorter. The dead zone TT is indicated adjacent to the “length difference=0” area. The upper length difference range is only shown schematically and ist located outside the measuring range of the reference sections. As can be seen from FIG. 9, the reference sections are set so that when the scan position changes and the measurement signal curve of a reference section leaves the active measuring range of said reference section, the measurement signal curve of an adjacent reference section enters the active measuring range of this adjacent reference section. The surface is therefore in the entire scan area from 0 mm to 200 mm always in an active measuring range of one of the reference sections.

As explained above, the optical path length OWL (x; y) corresponds to a measuring section that depends on the scan position (x; y). As a function of the configuration and position (x; y), the reference section may be longer or shorter than the measuring section. If it is longer, the reference section may be set so that the signal is set at the larger or upper edge of the active measuring range for the first or shortest reference section at scan position 0, for the second reference section at scan position approx. 60 mm, etc. (see FIG. 9). If the reference section is shorter than the measuring section, the smaller or lower edge of the active measuring range may be selected as the starting position. FIG. 9 shows that, with ideal alignment or arrangement, there is always an area in which signals from two (or more) reference sections can be detected. If the outer edge of the active measuring range nMB, pMB is reached for a reference section, a switch to the next useful reference section is made and it is adjusted until the peak thereof is apparent at the corresponding edge of the active measuring range. Other types of adjustment are conceivable.

The length of the individual reference sections is determined depending on the specifications, in particular component tolerance and/or scan range, and the configuration or structure of the laser machining system, in particular OCT detector, scanner device and optics. The definition of the lengths of the reference sections may also be derived from a simulation of the system, so the reference sections could be constructed with given lengths and only a fine adjustment made to the system. Each of the reference sections may then be implemented by a combination of defined fiber lengths and/or an adjustable free beam structure.

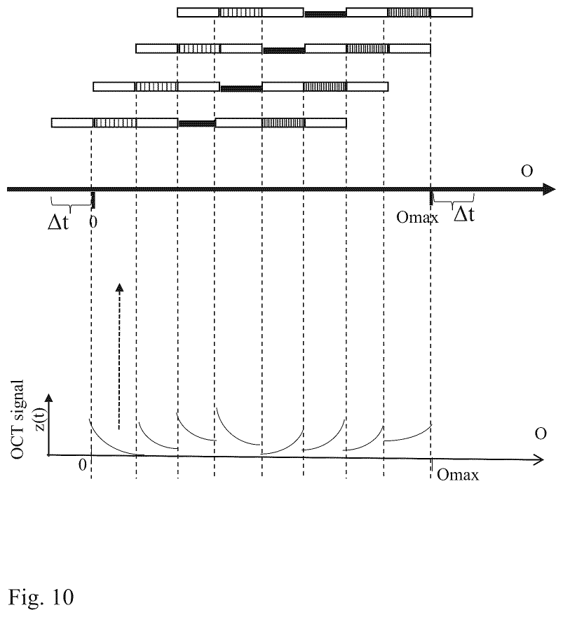

Due to opto-mechanical properties of the scanner system, the deflection of the scanning element (e.g. the scanner mirror) may cause a change in the optical path length to the target plane, which makes it necessary to calibrate the OCT signal or the distance value as a function of the deflection or the scan position. This is also apparent, for example, in the lower part of FIG. 10: Complex offsets with various dependencies may occur, in particular on the length of the individual reference sections, on the scan position, on an inclination of the laser machining system with respect to the working plane or workpiece surface, on the optical elements used (e.g. mirrors, lenses), etc.

After the reference sections have been set or the adjustment has been completed, a reference plane (e.g. a calibration plate) may be scanned in the entire scan area and OCT measurement signals may be recorded for the respective switch position of the switching element as a function of the scan position P (x; y). The measurement signals may be fitted with polynomials of at least second degree (e.g. according to the RANSAC algorithm). Furthermore, the relevant parameters (e.g. for curvature, inclination and offsets) may be specified. With these parameters, a model can be created that maps the OWL change as a function of x and y positions. The parameters depend on different physical quantities:
The calculated offsets of the functions for the respective switch position are related to the lengths of the reference sections.
The curvature of the function is determined primarily by properties of the scanner device, such as an arrangement of the scanning elements (e.g. a scanner-mirror arrangement and scanner-mirror distances), a working distance, and/or properties of the optical elements.
The inclination of the scanner device with respect to the workpiece support or to the workpiece surface determines the inclination of the function.

This model then provides the information for setting the switching element or which switch position is used at a given scan position P (x; y). This allows for correct distance measurement at each scan position P (x; y) in the scan area or scan field, which can be crucial for adjusting the process parameters. The following properties of the system can be extracted from the properties of this mathematical model for the optical path length as a function of on the scan position OWL (x; y):
Definition of the offsets of the measurement signals from the reference plane at the respective scan position P (x; y);
Assignment of switch position or setting to the coordinates of the scan area;
Inclination between the workpiece or workpiece support and the working plane of the scanner laser machining system;
Offset position of the individual reference sections;
Global offset of the entire system (i.e. all reference sections as a collective, in relation to the measurement plane).

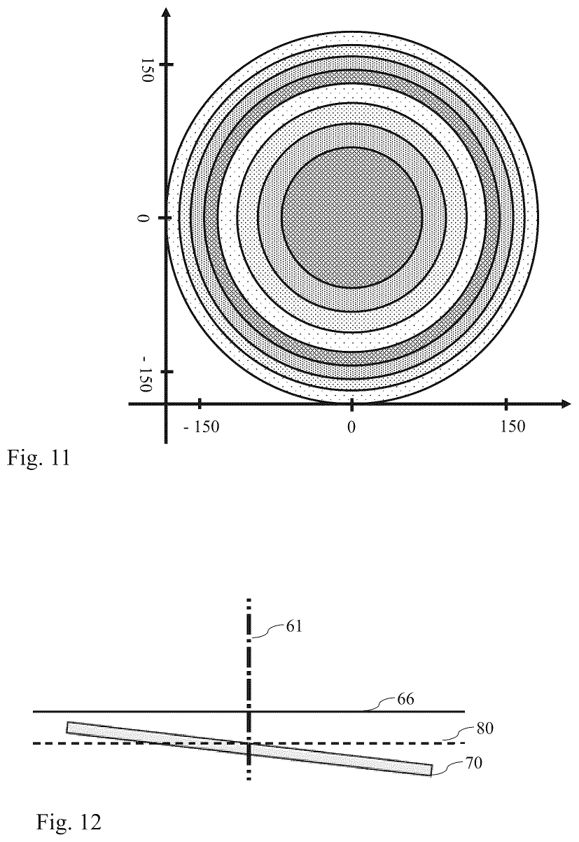

FIG. 11 shows an example of the splitting of a scan area of approx. 360 mm diameter into switch positions of the switching element. Each ring corresponds to a switch position or a reference section 511 of the reference arm 51. The width of the rings is defined by the mapping of the active measuring ranges aMB (i.e. nMB, pMB) in analogy to FIG. 9 (highlighted curve parts of FIG. 9 correspond to the areas in FIG. 11).

FIG. 12 shows a situation for a calibration plate 70 or workpiece support that is inclined with respect to the laser machining system. The optical axis 61 of the focusing optics 60 or the undeflected measuring light beam or laser beam is also shown. In the case of an F-Theta optic as the focusing optics 60, the focus lies in a planar focal plane 66. In this situation of an inclination between the workpiece or workpiece support and the laser machining system, a virtual working plane 80 may be defined that runs perpendicularly to the optical axis 61 and/or in parallel to the focal plane 66 and through an intersection point of the optical axis 61 with the calibration plate 70 or workpiece support. During calibration, an angle of inclination of the workpiece support or the calibration plate 70 with respect to the virtual working plane 80 can be determined as described above.

The parameters obtained from the calibration thus make it possible to determine an inclination between the workpiece support and the working plane 80 of the scanner laser machining system. This information may be used to inform the user whether tolerances have been exceeded or how pronounced this relative inclination is, so that the user can take corrective measures if necessary. Furthermore, a virtual working plane may be determined which is parallel and ideally identical to the focal plane of the laser machining system. The difference to the workpiece support can be taken into account in the measurement so that the actual distance from the measured point on the surface to the laser machining system is determined. This information can then be used when setting the system parameters—in particular when setting the collimator of the laser beam to set the focal position and/or when setting the focus setting of an integrated camera and/or when correcting the height of the working plane.

According to the present invention, it is made possible to extend the distance range in which an OCT measurement is possible by making the negative measuring range of a reference section usable alongside the positive measuring range of said reference section by cleverly arranging the reference sections. By switching to a complementary reference section, the range around the value 0 (“dead zone”) can be bridged. This ensures a reliable measurement without reaching the error-prone measuring range limits. The reference sections are set so that they complement each other in order to compensate for the greatest possible change in optical path length or to cover the greatest possible distance range O with the smallest possible number of reference distances.

### LIST OF REFERENCE SYMBOLS

50 Optical coherence tomography device
51 Reference arm
511 Reference section
   52 Measuring arm
   525 Measuring light beam
   53 Measuring light source
   54 Optical element
   55 Switching element
   57 Detector
   58 OCT processor or control
   59 Evaluation device
Distance range
   MB Measuring range
   TT Dead zone
   nMB Negative active measuring range
   pMB Positive active measuring range
   aMB Active measuring range
   nTB Negative tolerance range
   nTB1 Lower negative tolerance range
   nTB2 Upper negative tolerance range
   pTB Positive tolerance range
   pTB1 Lower positive tolerance range
   pTB2 Upper positive tolerance range
   1000 Laser machining system
   1100 System control or control device
   100 Laser machining head
   10 Laser beam
   15 Laser port
   20 Workpiece
   25 Component
   30 Scanner device
   35 Scanner control
   60 Focusing optics
   61 Optical axis of the focusing optics
   66 Focal plane
   80 Virtual plane

1. An optical coherence tomography device for a laser machining system for measuring a distance to an object in a predetermined distance range, comprising:
a measuring light source for generating measuring light;
an optical element for splitting the measuring light into the measuring light beam and a reference beam;
a measuring arm for directing the measuring light beam onto the object;
a reference arm for guiding the reference beam with a plurality of reference sections, each of which has a measuring range;
a controllable switching element for switching between the reference sections of the reference arm; and
a detector for detecting an interference signal between the measuring arm and the reference arm;
wherein the measuring range of each reference section comprises a negative active measuring range and a positive active measuring range, between which a dead zone is located;
wherein the dead zone of one of the reference sections is overlapped by a negative or positive active measuring range of at least one other reference section; and
wherein the positive and negative active measuring ranges of the reference sections together cover the predetermined distance range.

2. The optical coherence tomography device according to claim 1, wherein the reference sections of the reference arm comprise N reference sections, and:
the negative active measuring range of an nth one of the reference sections corresponds to smaller distance values than the negative active measuring range of an (n+1)th one of the reference sections, where N is a natural number greater than 1 and n is a natural number with 1≤n≤N; and/or
the positive active measuring range of an nth one of the reference sections corresponds to smaller distance values than the positive active measuring range of an (n+1)th one of the reference sections, where N is a natural number greater than 1 and n is a natural number with 1≤n≤N.

3. The optical coherence tomography device according to claim 1, wherein the reference sections of the reference arm comprise N reference sections, and the reference sections comprise at least one jth reference section, the negative active measuring range of the jth reference section being directly adjacent to the positive active measuring range of an ith reference section, where i and j are natural numbers with 1≤i<j≤N.

4. The optical coherence tomography device according to claim 2, wherein:
the reference sections of the reference arm comprise a group of M reference sections, where M is a natural number with 1≤M≤N; and
the following applies to each group:
the negative measuring ranges of (M−m) other of the reference sections and/or the positive measuring ranges of (m−1) other of the reference sections are arranged between a negative active measuring range and a positive active measuring range of an m-th one of the reference sections, where m is a natural number with 1≤m≤M.

5. The optical coherence tomography device according to claim 4, wherein the reference sections of the reference arm comprise K groups of reference sections which comprise the same number M of reference sections or different numbers Mk of reference sections; and
wherein a measuring range of a (k+1)-th one of the groups corresponds to larger distance values than a measuring range of a k-th one of the groups, where K is a natural number with 1<K and k is a natural number with 1≤k≤K.

6. The optical coherence tomography device according to claim 1, wherein the measuring range of each reference of the sections further comprise:
a positive tolerance range which borders on one or both sides of the positive active measurement range of the reference section; and/or
a negative tolerance range which borders on one or both sides of the negative active measurement range of the reference section.

7. The optical coherence tomography device according to claim 6, wherein the negative or positive tolerance range of one of the reference sections overlaps with a negative or positive active measurement range of at least one other of the reference sections.

8. The optical coherence tomography device according to claim 1, further comprising:
a control for controlling the switching element of the optical coherence tomography device;
wherein the control is configured to select one of the reference sections with the positive active or negative active measurement range according to a predetermined sub-range of the distance range and to switch to the selected one of the reference sections by means of the switching element.

9. The optical coherence tomography device according to claim 8, wherein the control is configured to switch to a shorter one of the reference sections for a distance measurement in a sub-range of the predetermined distance range with larger distances by means of the switching element.

10. A laser machining system, comprising:
a laser machining head for radiating a laser beam onto a workpiece;
an optical coherence tomography device according to claim 1; and
a control device for controlling the laser machining system.

11. The laser machining system according to claim 10, wherein:
the laser machining head comprises a scanner device with at least one scanning element for deflecting the laser beam to a plurality of positions on the workpiece; and
the control device is configured to select one of the reference sections for distance measurement in accordance with a scan command for adjusting the scanning element of the scanner device.

12. The laser machining system according to claim 11, further comprising:
an evaluation device configured to determine the distance based on the scan command and based on a superposition of a portion of the measuring light beam from the measuring arm reflected by the object and the reference beam from the reference arm.

13. The laser machining system according to claim 10, wherein the control device is configured to determine an alignment and/or inclination of the laser machining head with respect to a working plane and/or the workpiece based on distance values that were determined by the optical coherence tomography device during a scanning of the measuring light beam over the workpiece by means of the scanner device.

14. The laser machining system according to claim 10, wherein the control device is configured to assign reference height values to corresponding positions in a scan area of the scanner device and to determine the distance to the workpiece at a predetermined scanner position based on this assignment and a measurement at the scanner position.

15. The laser machining system according to claim 10, wherein the control device is configured to adjust system parameters and/or machining parameters based on the determined distance.
